(19) United States
(12) Patent Application Publication
(10) Pub. No.: US 2022/0135433 A1
(43) Pub. Date: May 5, 2022

(54) MULTI-POSITION FILTER

(71) Applicant: Elkay Manufacturing Company, Downers Grove, IL (US)

(72) Inventors: Erik Lynch, Downers Grove, IL (US); Bryan Miller, Downers Grove, IL (US)

(21) Appl. No.: 17/453,430

(22) Filed: Nov. 3, 2021

Related U.S. Application Data
(60) Provisional application No. 63/109,231, filed on Nov. 3, 2020.

(51) Int. Cl. C02F 1/00; B01D 29/15; B01D 35/30

(52) U.S. Cl. CPC C02F 1/003; B01D 29/15; B01D 35/30; C02F 2307/06; B01D 2201/44; B01D 2201/287; B01D 2201/291; B01D 2201/303; C02F 2307/12

(57) ABSTRACT

An apparatus is disclosed for a multi-position water filter. An example water filter includes a housing defining an internal cavity, the housing comprising a head including an inlet and an outlet, and a foot positioned opposite the head. The water filter also includes an inner filter assembly positioned in the internal cavity, the inner filter assembly comprising a head cap fluidly connected to the outlet, a foot cap, a filter media connected to the head cap and the foot cap, and an internal tube positioned in the filter media, wherein the internal cavity includes a radially oriented orifice configured to enable air to pass through, but prevent water from passing through.

### CROSS-REFERENCE TO RELATED APPLICATIONS

This application claims the benefit of U.S. Provisional Patent Application No. 63/109,231, filed Nov. 3, 2020, which is fully incorporated by reference in its entirety herein.

### TECHNICAL FIELD

The present disclosure generally relates to water filters and, more specifically, a water filter that can be used in multiple different orientations.

### BACKGROUND

Water filters typically are configured to physically remove solid matter or suspended impurities from a stream of water. Some water filters provide whole house filtration, appliance filtration, or filtration of drinking water as it exits a faucet. As such, water filters can be used in various configurations and orientations. For example, a water filter can be inserted into an appliance (such as a refrigerator) such that water passes through the filter prior to exiting the refrigerator via an outlet typically placed on the front. In another example, a water filter may include a connector such that it is connectable to a faucet, and configured to filter water directly as it exits the faucet.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for multi-position water filters. An example of the disclosed multi-position water filter includes a housing defining an internal cavity, the housing comprising: a head including an inlet and an outlet, and a foot positioned opposite the head. The water filter also includes an inner filter assembly positioned in the internal cavity, the inner filter assembly comprising a head cap fluidly connected to the outlet, a foot cap, a filter media connected to the head cap and the foot cap, and an internal tube positioned in the filter media, wherein the internal cavity includes a radially oriented orifice configured to enable air to pass through, but prevent water from passing through.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example filter oriented in a head-on-top orientation.

FIG. 2 illustrates the example filter of FIG. 1, oriented in a head-on-bottom orientation.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

As noted above, water filters can be used in a variety of applications, including large scale water filtering (e.g., whole home filtering), appliance filtering (e.g., a refrigerator or as part of a sink), and/or attached to an outlet of a faucet. In each of these applications, filters are typically designed with a static orientation in mind, such as being limited to either vertical or horizontal orientation, positioning a “head” of the water filter through which water flows in and out above the central axis of the filter.

Typical water filters allow for the water stream to pass through certain filter media to physically remove solid matter or suspended impurities from the stream of water. One problem that arises with typical water filters is the accumulation of air in the filter media and/or inside the housing containing the filter media when a head of the filter is positioned below a central axis of the filter, such as when a filter is installed in a device in an orientation for which it was not designed. The accumulation allows an air pocket to form, which prevents the flow of water through portions of the filter media. This in turn causes a reduction in the flow rate of the filter as well as the operable lifetime of the filter.

Embodiments of the present invention incorporate an orifice in the filter, which enables air flow but restricts water flow, so as to limit the accumulation of air inside the filter, regardless of the orientation of the filter. This enables the filter to be installed and used in multiple positions or orientations while minimizing the issues caused by the accumulation of air.

To address the accumulation of air, a tube is positioned within an inner diameter of the filter media of the water filter. The tube is open at a first end, and connected to the outlet at the second end. The tube includes a radially oriented orifice sized to enable the passage of air, but to prevent the passage of water when operating at a desired operating pressure. The orifice is positioned axially at a position with respect to the tube near the outlet. In this manner, any air pocket that forms is restricted from extending past the orifice (when the orifice is positioned above the open first end of the tube), or is restricted from extending past the first end of the tube (when the orifice is positioned below the open first end of the tube). The water filter can then be installed and operate in either a “head-on-top” orientation or a “head-on-bottom” orientation while negative effects from the accumulation of air are minimized.

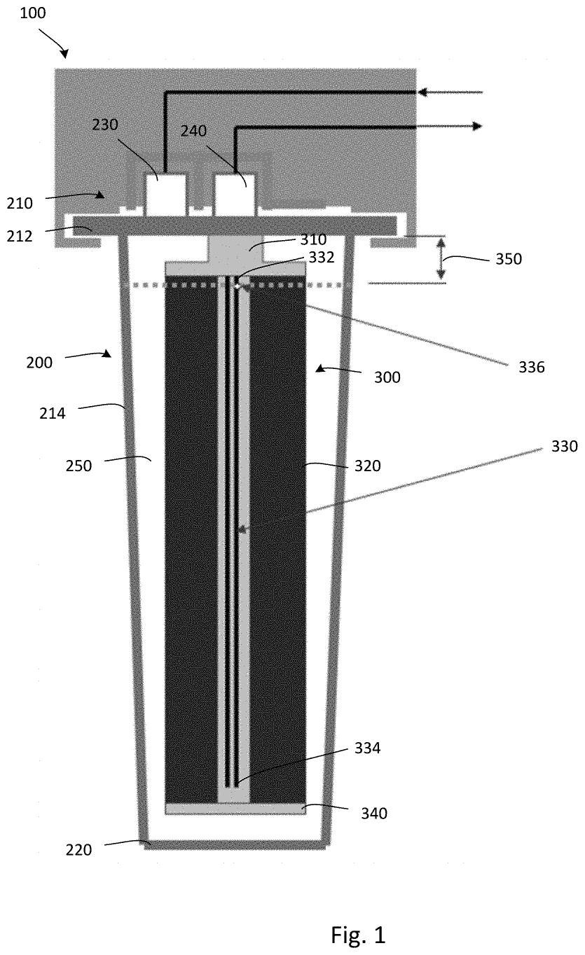

FIG. 1 illustrates an example embodiment of the multi-position filter of the present disclosure. In the example shown in FIG. 1, the filter 100 includes a housing 200 and an inner filter assembly 300.

The housing 200 includes a head 210 and a foot 220. In some examples, the housing is generally circular or cylindrical. FIG. 1 illustrates a generally cylindrical housing 200 that is tapered from the head 210 to the foot 220, such that the foot 220 has a smaller cross section than the head 210. This configuration may enable easier installation and removal of the filter 100.

The housing 100 defines an internal cavity 250, into which unfiltered water flows. The internal cavity 250 extends the length of the housing 200 between the head 210 and the foot 220.

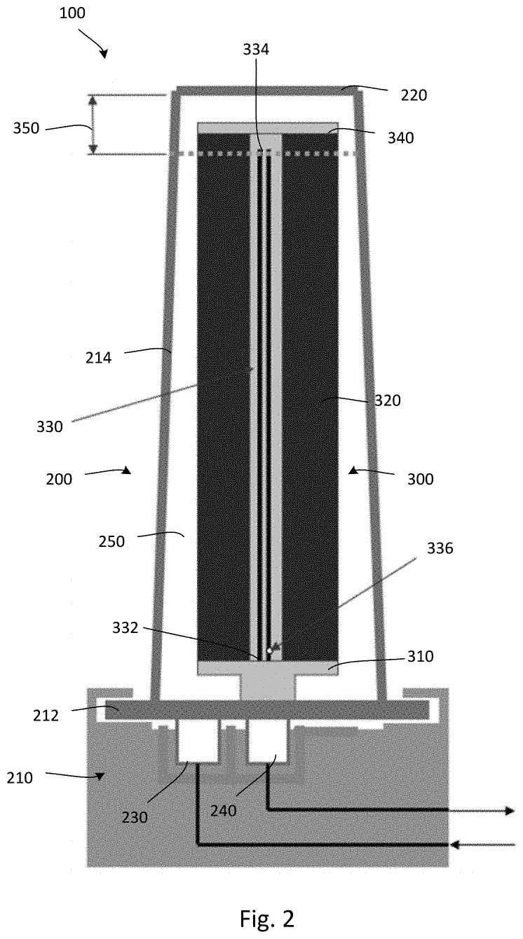

Head 210 includes a lip 212 configured to assist with installation, for example, into an appliance. The lip 212 extends beyond an outer radius of the body 214 of the housing 200, as shown in FIGS. 1 and 2. In some examples, the head 210 is thicker than the body 214 of the housing 200.

The head 210 includes an inlet 230 and an outlet 240. The inlet 230 is configured to enable unfiltered water to flow into the inner cavity 250 of the housing 200. The unfiltered water is then filtered by the filter media as noted below. After being filtered, the water then flows out of the outlet 240. In some examples, the inlet 230 and the outlet 240 are axially oriented with respect to the housing 200, such that water flows into and out of the inlet and outlet generally parallel to a longitudinal axis of the filter 100. Additionally, the inlet and the outlet are positioned on the same side of the filter 100, as shown in FIGS. 1 and 2.

The inner filter assembly 300 includes a head cap 310, filter media 320, an internal tube 330, and a foot cap 340. The inner filter assembly 310 is configured to take the unfiltered water input into the internal cavity 250 of the housing 200, filter the water by passing it through the filter media 330, and pass the water out of the housing 200 via the outlet 240.

The head cap 310 is attached to the housing 200 and the filter media 330, such that filtered water flows from the internal cavity 250 external to the filter media 330, through the filter media 330, and out the outlet 240 by passing through the head cap 310.

The filter media 320 may be any suitable filter media, including activated carbon, catalytic carbon, KDF (Kinetic Degradation Fluxion), mixed-media, a reverse osmosis membrane, ultra violet light (e.g., UV filtration), activated aluminum, manganese dioxide, and more. The filter media 320 may be shaped to match, or be close to matching the body 214 of the housing 200. In the example shown in FIGS. 1 and 2, the filter media 320 is cylindrical in shape, and extends along the longitudinal axis of the filter 100.

An internal tube 330 is positioned at a center of the filter media 320. The internal tube 330 includes a first end 332 attached to the head cap 310, and a second end 334 extending toward the foot cap 340. The internal tube 330 is hollow, and enables water to flow into the second end 334 and out of the filter 100 via the outlet 240

The internal tube 330 also includes an orifice 336. The orifice 336 extends radially from the internal tube 330. The orifice 336 is positioned proximate the head cap 310. The orifice is sized such that air can flow through, and such that water is prevented from flowing through. The sizing may be such that surface tension prevents water from flowing through, but allows water to pass through. The size of the orifice 336 may be dependent upon the operational pressure of the filter 100. For example, a high pressure filter may include a smaller orifice than a low pressure filter, since higher pressures may alter the surface tension such that water flows through a smaller orifice than it otherwise would.

In operation, the positioning of the orifice 336 near the head cap 310 prevents air from extending past the orifice 336 when the filter 100 is used in a head-on-top orientation, as shown in FIG. 1. In typical water filters, leakage, imperfect seals, and various other issues can cause air to enter the housing 200. This air may become trapped, which leads to various operational issues. In the disclosed embodiment, the positioning of the orifice 336 proximate the head cap 310, however, limits the size of the resulting air pocket 350. Rather than continuing to expand down into the internal cavity 250, the air pocket 350 is limited to the space above the orifice 336. When the air reaches the orifice 336, the air flows through the orifice 336 and out the outlet 240. Since air is less dense than water, the air will rise to the top of the filter 100 when in the head-on-top orientation of FIG. 1. As a result, a larger portion of the filter media 320 will remain usable for a longer period of time, and the life of the filter 100 will be extended.

The foot cap 340 is attached to the filter media 320 proximate the foot 220 of the housing 200. The foot cap 340 prevents unfiltered water from entering the internal tube 330, or the interior of the filter media 320, without first being filtered through the filter media 320.

FIG. 2 illustrates the same filter 100 as illustrated in FIG. 1, in a head-on-bottom orientation. In the head-on-bottom orientation, any air that leaks into the inner cavity 250 rises to the top, near the foot 220 of the housing 200. As more air leaks in, and the air pocket 350 increases, the size of the air pocket 350 is limited by the area defined by the foot 220 and the second end 334 of the internal tube 330. As the air pocket 350 reaches the second end 334, it escapes through the internal tube 330 and out the outlet 240. As a result, a larger portion of the filter media 320 will remain usable for a longer period of time, and the life of the filter 100 will be extended.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A water filter comprising:
a housing defining an internal cavity, the housing comprising:
a head including an inlet and an outlet; and
a foot positioned opposite the head; and
an inner filter assembly positioned inside the internal cavity, the inner filter assembly comprising:
a head cap fluidly connected to the outlet;
a foot cap;
a filter media connected to the head cap and the foot cap; and
an internal tube positioned inside the filter media, the internal tube defining a radially oriented orifice.

2. The water filter of claim 1, wherein the head and the foot of the housing are parallel to each other, and wherein the housing is tapered such that a width of the head is greater than a width of the foot.

3. The water filter of claim 1, wherein the inlet and the outlet are axially oriented with respect to a longitudinal axis of the housing.

4. The water filter of claim 1, wherein the head cap is positioned along a central longitudinal axis of the water filter, and wherein the outlet of the head is positioned along the central longitudinal axis of the water filter.

5. The water filter of claim 1, wherein a shape of the filter media matches a shape of the housing.

6. The water filter of claim 1, wherein the filter media comprises one or more of activated carbon, catalytic carbon, KDF (Kinetic Degradation Fluxion), mixed-media, a reverse osmosis membrane, ultra violet light, activated aluminum, or manganese dioxide.

7. The water filter of claim 1, wherein the internal tube is hollow and has a first end attached to the head cap of the inner filter assembly, and a second end extending toward the foot cap of the inner filter assembly.

8. The water filter of claim 7, wherein the first end of the internal tube enables water to flow from the internal tube into the head cap of the inner filter assembly.

9. The water filter of claim 7, wherein the second end of the internal tube is open, and allows water to flow through the second end into the internal tube.

10. The water filter of claim 1, wherein the internal tube is positioned in line with the head cap of the inner filter assembly and the outlet of the head of the housing.

11. The water filter of claim 1, wherein the radially oriented orifice is positioned along the internal tube proximate the head cap of the inner filter assembly.

12. The water filter of claim 1, wherein the radially oriented orifice is oriented perpendicular to a longitudinal axis of the housing.

13. The water filter of claim 1, wherein the radially oriented orifice is configured to enable air to pass through and to prevent water from passing through.

14. The water filter of claim 1, wherein the water filter is configured to operate in a first orientation wherein the head of the housing is positioned above the foot of the housing, and a second orientation wherein the head of the housing is positioned below the foot of the housing.

15. The water filter of claim 14, wherein in the first position, the inner filter assembly is configured to limit the size of an air pocket to extending between the head of the housing and the radially oriented orifice of the internal tube.

16. The water filter of claim 14, wherein in the second position, the inner filter assembly is configured to limit the size of an air pocket to extending between the foot of the housing and a second end of the internal tube.

17. An inner filter assembly for a water filter comprising:
a head cap fluidly connected to an outlet of the water filter;
a foot cap positioned opposite the head cap;
a filter media connected to and extending between the head cap and the foot cap, the filter media defining a central cavity; and
an internal tube positioned in the central cavity of the filter media, the internal tube defining a radially oriented orifice.

18. The inner filter assembly of claim 17, wherein the internal tube is hollow and has a first end attached to the head cap of the inner filter assembly, and a second end extending toward the foot cap of the inner filter assembly.

19. The inner filter assembly of claim 18, wherein the first end of the internal tube enables water to flow from the internal tube into the head cap, and wherein the second end is open and enables water to flow into the internal tube.

20. The inner filter assembly of claim 17, wherein the radially oriented orifice is positioned proximate the head cap, and wherein the radially oriented orifice is configured to enable air to pass through and to prevent water from passing through.
